(19) United States
(12) Patent Application Publication
(10) Pub. No.: US 2007/0061869 A1
(43) Pub. Date: Mar. 15, 2007

(54) Access of Internet use for a selected user

(76) Inventor: Ronald J. DeHaas, Corunna, MI (US)

Correspondence Address: DICKINSON WRIGHT PLLC, 1901 L. STREET NW, SUITE 800, WASHINGTON, DC, 20036, US

(21) Appl. No.: 11/491,918

(22) Filed: Jul. 25, 2006

Related U.S. Application Data
(60) Provisional application No. 60/701,938, filed on Jul. 25, 2005.

(51) Int. Cl. H04L 9/32

(52) U.S. Cl. 726/2

(57) ABSTRACT

A system for the provision of accountability for and blocking of Internet use of a selected computer user. The system includes a computer which has Internet access blocked, a remote server, and a second computer at which an Accountability Partner communicates to the remote server, such that Internet access is permitted to the person using the first computer. The Internet access activity includes access of at least one Internet protocol from the group consisting of newsgroups, file sharing programs, file transfer programs, chat rooms, peer to peer chats cell phone or PDA transmissions, http, https, and electronic mail activity.

### CLAIM OF PRIORITY

This Application claims priority to and the benefit of U.S. Provisional Application No. 60/701,938, filed Jul. 25, 2005, which is incorporated by reference herein in its entirety.

### FIELD OF THE INVENTION

The present invention generally relates to a computer program and system, which blocks access to Internet use, and for providing a means for a remote server, and optionally a second computer connected to that remote server, to unblock and permit access to the Internet, for example, on a time interval basis; the computer system provides a means for blocking or permitting the access of Internet use of a selected user to which the program is installed, and more particularly to provide accountability for and unblocking and permitting Internet use, said permission to be allowed by an accountability partner through a remote server. The computer program is configured to block connections for multiple Internet access activities, such as web browsing, file sharing programs, news groups, chat rooms, peer to peer chats, cell phone or PDA transmissions, and electronic mail file transfer protocols, sent and received, and the like, and is also configured to be unblocked by a remote server.

### BACKGROUND OF INVENTION

Although it would be desirable or even necessary to block access to objectionable material from some users in web sites and the like, this is often not possible as a practical matter. However, such blocking may either compulsorily or voluntarily permit the usage of a selected computer Internet access or in some case televisions by a selected third party recipient, such as an accountability partner of a particular user of web sites or channels accessed.

U.S. Pat. No. 6,804,334 describes a method and device for dynamic message delivery based upon the identification of an originating caller. Specifically, the originating caller for an incoming call is identified and compared to a list of callers, where each caller within the list of callers is associated with one of a plurality of dispositions, the dispositions including accept, reject and forwarding of an incoming call. The incoming call is routed based upon the disposition associated with the identified originating caller. In the case of a subscriber utilizing a dial-up Internet account, a message is sent to the subscriber via the Internet connection alerting the subscriber that an incoming call is present and offering the subscriber various disposition options. Although one of the embodiments of this invention states that providers may use the system for each caller within the list of callers is associated with one of a plurality of dispositions, the dispositions including accept, reject and forwarding of an incoming call via an Internet connection, it does not describe how the system could be adapted for use disclosed above, but mainly describes the use as applied to telecommunication.

Site specific Internet usage monitoring programs are also generally known in the art. Such monitoring programs may be installed by employers or parents to monitor the web sites visited by employees or children respectively. It may also be desirable to monitor web sites accessed by other persons under a variety of different circumstances. Involuntary applications of these types of programs are often used by employers. The employee has no choice but to accept the monitoring activity on the computer since they have no expectation of privacy for business owned systems. In a voluntary monitoring system, the user knowingly and voluntarily has the monitoring program installed on a particular computer to monitor his Internet activities. The user may even select one or more third party recipients to receive, or have access to a report containing a record of the Internet activity of the computer user. For example, U.S. Pat. No. 6,606,657 to Zilbertstein, et al., describes a system to gather and report detailed information on a user's web site visitation. Here, a server system is connected to the Internet and receives, processes and supplies detailed user information such as the sites visited and the duration and times of such visits. Such information is gathered and transmitted to subscribers who have reporting and communicating software installed. In addition, the users submit profile information about themselves. Demographic information as to the popularity of visited web sites may then be easily determined, stored and updated by the server. This demographic information, in turn, may be provided to other users, or web site operators and advertisers. The invention disclosed also allows users to initiate chat sessions with other users visiting a particular web site, or post a virtual note on the site for other subscribers to read. A disadvantage to this invention is that most of the web monitoring information is provided to the website owners and operators not the users.

U.S. Pat. No. 6,449,604 to Hansen, et al. describes a system for displaying information on the Web page usage. Statistical information and usage analysis produced by this invention is available to owners and web-site operators. A disadvantage to this invention is that it focuses on website use, not a user's usage. U.S. Pat. No. 6,052,730 to Feliciano, et al. discloses a method for monitoring web browsing activities that does not require modification or reconfiguration of client software, and does not require information from other servers. Complete tracking of a client browsing session is allowed, including detailed link usage, page visits, and the sequence in which the accessing took place. The invention also allows such tracking information to be generated and recorded through the use of a single server. The disadvantage to this invention is that the method is transparent to the client browser.

U.S. Pat. No. 6,397,256 to Chan, et al. describes a device for transmitting browser activity to a monitoring unit. The monitoring unit is remotely located from the Internet access unit and coupled to the transmission device, the monitoring unit including a display for viewing, and recording Internet activity of the Internet access unit. The system may be activated via a remote command module and may include a password protected interface on the Internet browser (via the software plug-in). Unfortunately, this system is fairly complicated in that it requires an installed transmission adapter card.

At http://safebrowse.com/press release/01.31.05 an invention is disclosed in which a third-party delegated administrator has the ability to remotely (through a server) configure a user's Internet monitoring program in such a way that it locks out the user from using “features” that could be used to bypass the software. The invention has the disadvantage of allowing, by default, the user to have access to all Internet protocols, and thereby requiring the third party proactively to selectively block each protocol; as the third party may not be aware of all the protocols, or as new protocols are available, the user could readily and regularly have access to unmonitored protocols, which would therefore provide no effective control by the third party. This invention also has another disadvantage of not providing predetermined times at which specific Internet protocols may be accessed. Thus, it would be desirable to have a program that does not require proactive measures by the third-party Accountability Partner to block access (by the user) to any Internet protocol, but which instead blocks access, as the default position, to all Internet protocols, thereby requiring proactive permission by the third party, and which instead allows the Accountability Partner (the third party), through a server, to selectively allow access only to selected protocols, either upon request of the user, or at predetermined times.

While the voluntary programs currently available in the art are configured to monitor or block web sites accessed by the computer user, they do not offer the capability of a computer user to always have all Internet usage blocked, with the concomitant ability for an accountability partner, by means of a remote server, to unblock Internet activities, either completely or selectively, resulting from use of http, https, or other protocols, such as access to file share programs, news groups, chat rooms, peer to peer chats, cell phone or PDA transmissions, and electronic mail file transfer protocols, for example, pre-selected or on request time intervals.

Although there is known in the art various means to monitor computer use, there is a desire and need in the art to provide a method of blocking Internet activities of a particular computer user including web browsing activity, file share programs use, news group access, chat room activity, peer to peer chat activities, file transfer protocol use, e-mails sent and received, and the like, in a way such as to allow an accountability partner of a user to unblock, and selectively allow, access to Internet activities resulting from use of http, https, or other protocols, such as access to file share programs, news groups, chat rooms, peer to peer chats, file transfer protocols, and e-mails. This blocking and unblocking could then be recorded and the record made available to not only the user, but also to a third party recipient. There is a further need to provide an Internet monitoring program capable of generating and providing a report having information related to the above described Internet activities.

### SUMMARY OF INVENTION

Accordingly, the present invention provides a means of unblocking and permitting Internet use of a particular computer user including web browsing activity, file sharing program access, news group access, chat room activity, peer to peer chat activity, file transfer protocol access, and e-mails sent and received. Currently there are a limited number of ways to block and unblock access to objectionable material from users in web sites and the like. The system and method of the present invention relates to a computer program and system for providing unblocking, accountability, monitoring, and optionally, recording Internet use of a selected user. The computer system provides a means for blocking or permitting the access of Internet use of a selected user to which the program is installed, and more particularly to provide accountability for and unblocking of Internet use.

The computer program is configured to monitor and/or permit connections for multiple Internet access activities, such as web browsing, file sharing programs, news groups, chat rooms, peer to peer chats, cell phone or PDA transmission, and electronic mail, file transfer protocols, sent and received, and the like.

In one embodiment of the present invention, a system for permitting Internet use of a selected computer user includes a remote server and a computer communicatively connected to the remote server. The program is configured to permit or deny Internet access activity of the computer user and may record the Internet access activity on the remote server. The Internet access activity includes at least one Internet protocol from the group consisting of http, https, network news transfer protocols, file sharing programs, file transfer protocols, chat room access, peer to peer chat access and electronic mail activity.

In another embodiment of the present invention, a method of permitting Internet use of a selected computer user includes the steps of: a user installing a program on the computer, the program linked to a remote server, the program is configured to block all Internet access unless Internet access is permitted by the remote server. Internet access includes at least one Internet protocol from the group consisting of http, https, newsgroup access, file sharing programs, file transfer protocols, chat room activity, peer to peer chat activity and electronic mail activity; monitoring the Internet access activity; and recording the Internet access activity on a first database located within a remote server.

In yet another embodiment of the present invention, a system for permitting Internet access of a selected computer user includes a remote server and a computer communicatively connected to the remote server having a monitoring program installed thereon. The monitoring program is configured to monitor Internet access activity of the computer user and record the activity on the remote server. The Internet access activity includes access to at least one Internet protocol from the group consisting of hyper text transfer protocol, https, network news transfer protocol, file sharing programs, file transfer protocol, chat rooms, peer to peer chats, cell phone or PDA transmissions, and electronic mail. The remote server is further configured to generate a report including a plurality of portions, and each portion containing a list of the recorded Internet access activity of one of the Internet protocols. The portions may further include a computer link to connect to another of the plurality of portions.

In still another embodiment of the present invention a method of reporting permitted Internet use of a selected computer user includes the steps of: a user voluntarily installing an Internet monitoring program on the computer, the program being configured to monitor Internet access activity of the user; monitoring the Internet access activity; generating a report of the Internet access activity, the report including a plurality of portions; and providing a link on one portion of the report to electronically connect to at least one other portion of the report, wherein each of the plurality of portions contain information on Internet access of different Internet protocols.

Other features of the present invention will become more apparent to persons having ordinary skill in the art to which the present invention pertains from the following description and claims.

### BRIEF DESCRIPTION OF THE FIGURES

The foregoing features, as. well as other features, will become apparent with reference to the description and figures below, in which like numerals represent elements, and in which:

FIG. 1 is a schematic of a hardware that can be used to implement the objectives of the current invention; and

FIG. 2 is a flow diagram for a system for access of internet use for a selected user in accordance with the present invention.

### DETAILED DESCRIPTION OF THE INVENTION

In general, the present invention can be realized as methods or systems in hardware, software, or a combination of hardware and software of a computer system including a computer network system. The present invention can be realized in a centralized fashion in one computer system or in a distributed fashion where different elements are spread across several computer systems. Any kind of computer system, or other apparatus adapted for carrying out the methods described herein, is suited. A typical combination of hardware and software may include a general purpose computer system with a computer program that, when being loaded and executed, controls the computer system such that it carries out the systems and methods described herein. Cell phones, PDA's and other similar products can also be a computer system capable of carrying out the objects of the present invention. The present invention may also be voluntarily embedded in a computer program product (or any computer useable medium having computer readable program code embodied therein), which comprises all the features enabling the implementation of the methods and systems described herein and which when loaded in a computer system is able to carry out these systems and methods.

Computer program or computer program product in the present context means any expression, in any language, code or notation, of a set of instructions intended to cause a system having an information processing capability to perform a particular function either directly or after either or both of the following: (a) conversion to another language, code or notation, and (b) reproduction in a different material or electronic form.

The present invention specifically relates to an Internet system for the provision of accountability for and unblocking of Internet use of a selected user. The use of a particular computer user including http, https, all other web browsing activity, file sharing program access, news group access, chat room activity, file transfer programs access, e-mails sent and received, and the like, and providing a report to a third party recipient. This type of Internet system, may provide a user of a computer with said program and system installed with a method to minimize temptations to engage in Internet access activities considered objectionable. If the user knows an accountability partner will have to permit access and may optionally report on his Internet access activity, thus eliminating the secrecy of the activity, he may refrain from such objectionable activity.

The present invention also provides reporting features superior to existing means of blocking and accessing Internet use, thus enhancing its usefulness and effectiveness. The report generated in the present invention is capable of reporting the Internet access activity of the user and may also provide a link on one portion of the report to allow the user to computerlink to and access information related to different Internet protocol activities on different portions of the report.

The software may be installed by down-loading the program directly from a remote server through an Internet connection or other suitable means, or may alternatively be installed manually by way of a pre-recorded media, such as a compact disc (CD). Before installing the program, the user may make certain pre-installation elections such as who will have the ability to unblock and permit access, who will be the recipient of information gathered with the program, how often reports will be updated and made available to either the user or a accountability partner, as well as other key parameters that will be discussed in more detail below.

Once the program has been installed on the first computer, this computer is communicatively connected to a server through an electronic connection, such as telephone lines, cable, fiber optics, electric power lines, or other suitable connection. When the user attempts to connect to the Internet, the user will be unable to gain access to the Internet without first establishing a connection with remote server, and without that server unblocking or permitting access as predetermined by accountability partner. During or after the initial installation of the program, the user may elect to have an automatic connection to remote server and thus always be available for unblocking of access to the Internet by the remote server. When the server permits access (at the direction of the Accountability Partner), the user may or may not have a prompt display on the screen of computer indicating that a password is required to enter the Internet. This password would then connect the first computer to remote server. The remote server may include any personal computer or other hardware system available and known in the art. Server may be a single server or include a “server cluster” containing multiple servers.

When the program is installed on the first computer, during any given session of Internet access, all Internet access activity of the user can optionally be recorded by the monitoring program onto the remote server. These activities may include the traditional web site protocols, such as hyper text transfer protocol (http) (i.e., web browsing activities), in addition to other protocols not presently able to be monitored by existing monitoring programs. These other protocols may include protocols used in file sharing programs (gnutella, fast track and other like programs), news group access or network news transfer protocol (nntp), chat room activity and peer to peer chats, file transfer protocols (ftp), and protocols for reading e-mail such as post office protocol 3 (pop3) and Internet message access protocol (IMAP), cell-phone and PDA (personal digital assistant protocol) and protocols for writing or sending emails such as simple mail transfer protocol (smtp). As other new protocols are developed, the system may be reconfigured to add monitoring and reporting capabilities for those as well. These may be added as program updates, new releases and the like. The Internet access activity being monitored may be routed over the Internet, compiled then stored in remote server or in a database contained within remote server.

The information processing performed by processing program may include sorting the access activity of the user, assembling a list of the Internet access activity, and assigning a score to each activity listed. In one scenario, a score may be assigned as a numeric indicator of the type of activity accessed. For instance, for a particular type of objectionable Internet activity accessed a high numeric score may be assigned such as a number between 15 and 20. Likewise, a non-objectionable Internet access activity may be assigned a low number such as 0 or 1. An analysis program within the processing program may analyze the Internet access activity and assign a score based on parameters such as key words and image content.

Alternatively, instead of the default scoring system, the user or recipient can pre-select key words and/or other selected parameters to use for scoring purposes. In this scenario, a program will run for that particular user that assigns the score to the Internet access activity listed in accordance with the desired scoring for that user. For example, the user or recipient may select words to be given a high numeric score (i.e., words considered objectionable to that user or recipient), and words to be given a low numeric score. A variety of other scoring parameters may be included such as scoring based on the time of day (or night) the user engaged in Internet access activity, or the size of the file accessed by the user. Again, the score may be higher for activities logged late at night as opposed to during the day. As an alternative to the scenario described above, the numeric scoring may be replaced with a relative scoring system. Under this type of scoring method, for a particular activity a letter or other symbol may be used that designates whether the activity is deemed objectionable or not.

Another feature of the program may include a comment section. The comment section may allow the user to type in a comment after engaging in a particular Internet access activity. For example, if the user conducted research for a school report, and visited a web site considered objectionable to the user, he may later access the report of that activity within remote server and type in a comment explaining the visit to that site. The comment may then appear on the report to alert the third party recipient of the reason for the activity listed on the report.

Together, this invention can be used, for example, to allow a parolee to have access only at times permitted by a remote parole officer; or to allow a pornography addict to call his Accountability Partner to allow access only on an as-needed basis to the Internet; or for a child to allow parents to establish appropriate times of Internet use; or other applications as may be appropriate.

Implementation could, for example, be for the Accountability Partner using any computer in the world with internet access to go to the Covenant Eyes Member Center, https://secure.cvnt.net/member/,Log In, and have a menu of selection for the User, which would permit the Accountability Partner to choose the amount of permitted time access, the times of day the access is permitted, whether such access is to be on a regular basis, and which Internet protocols are permitted. Alternatively, the Accountability Partner could provide his/her password by telephone, or by other electronic means.

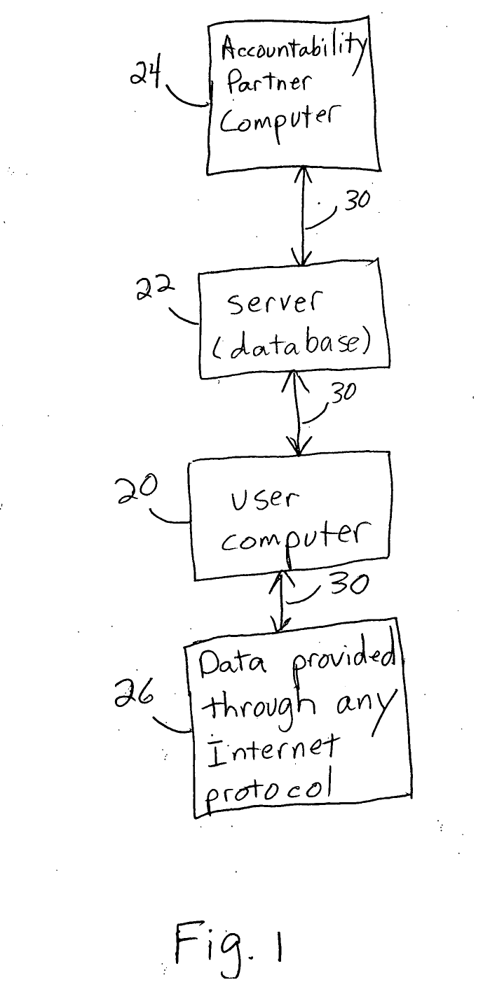

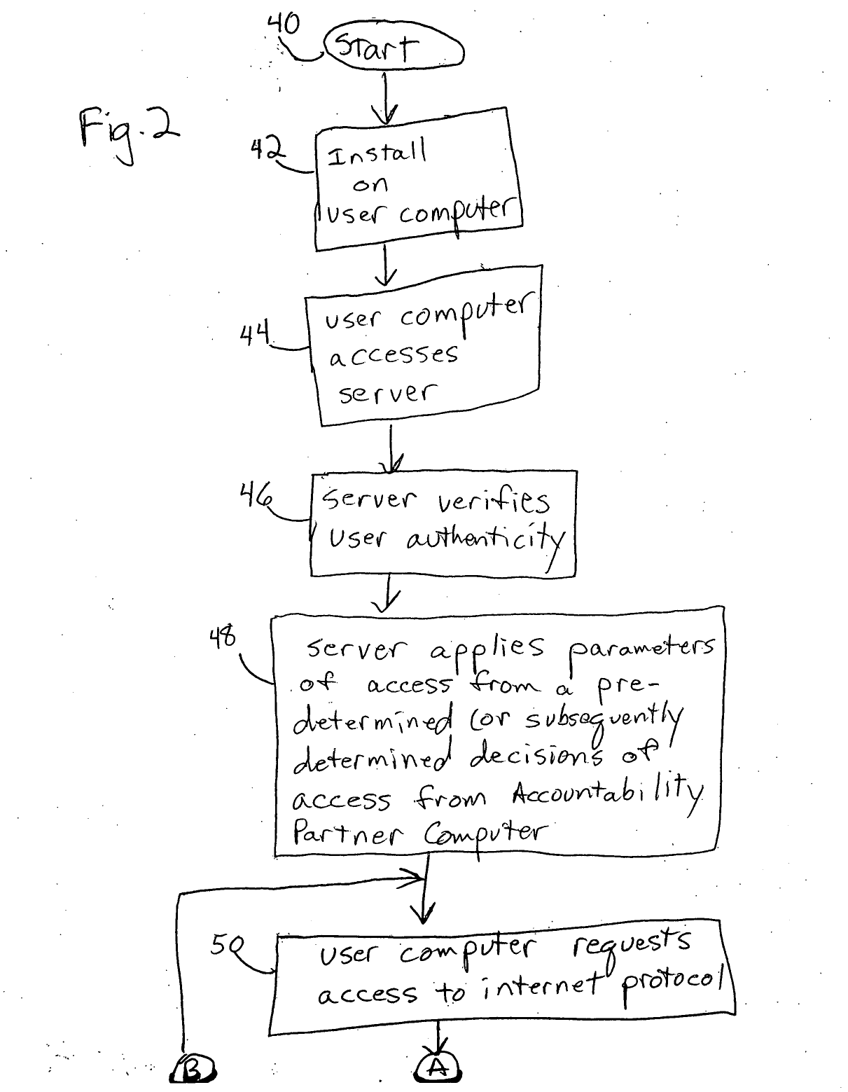

Referring now to the figures, FIG. 1 is a schematic of a hardware configuration that can be used to implement the objectives of the present invention. As shown, the system has a first computer that is a user computer 20 that is communicatively connected at 30 to a server 22 by any networking means such as the Internet. Server 22 have a database and is similarly communicatively attached to a second computer 24 for use by an accountability partner. Further, user computer 20 is also communicatively attached to any data source 26 received through any type of Internet protocol. As used in the present invention as stated above, computer means any device that can process digital information such as a personal computer, PDA, cell-phone, and the like.

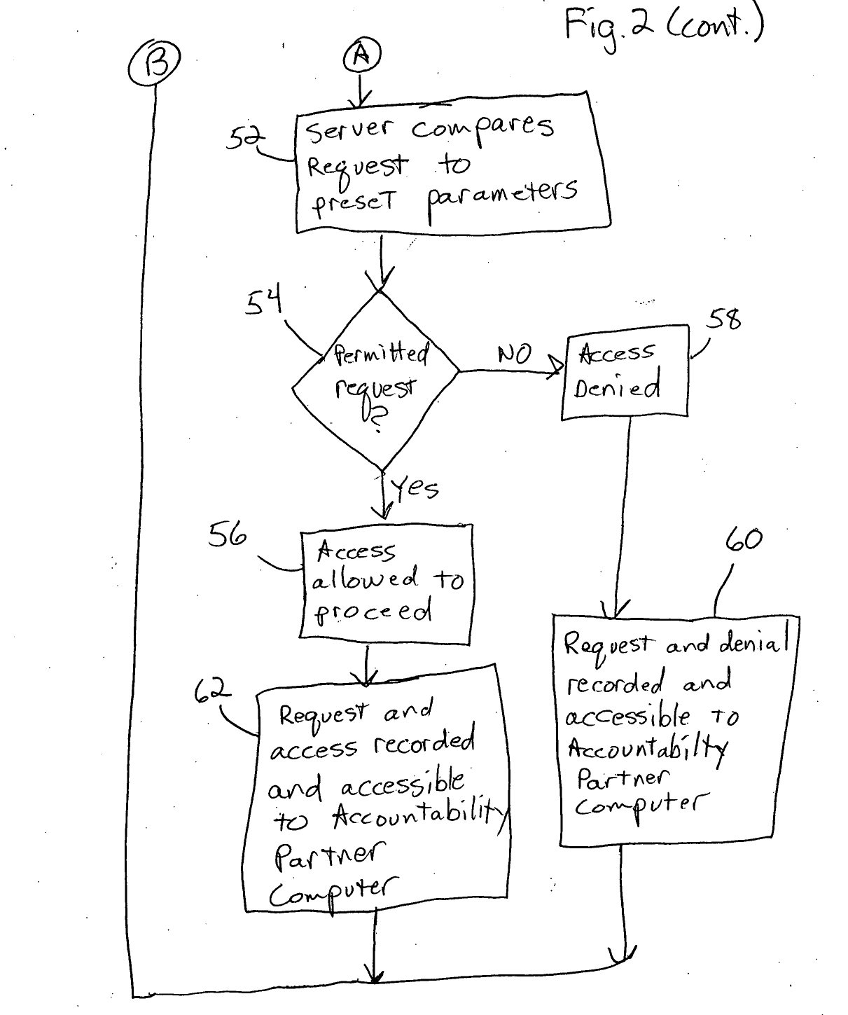

Referring now to FIG. 2, is shown a flow of a system that embodies the objectives of the present invention. The system starts at Step 40 and proceeds to Step 42 where the program installs on User Computer 20. As part of the installation the system proceeds to Step 44 where the system accesses Server 22 database so that at Step 46 Server 22 can verify user authenticity in Server 22 database. Next the system proceeds to Step 48 where Server 22 accesses its database to apply User computer 20 Internet access parameters from a pre-determined or subsequently-determined list received from the Accountability Partner Computer. The system then waits for User Computer to make an access request, which is found at Step 50.

When an access request is received by the system from User Computer 20, the system proceeds to Step 52 where Server 22 compares the request to the preset access parameters. The system then proceeds to Step 54 to determine if the request falls within the list of allowed access sites. If yes, the system proceeds to Step 56 where access to the site is allowed per the predetermined parameters (such as a time interval). If no at Step 54, the System proceeds to Step 58 where access to the site is denied.

From this point, the system at Step 58 may at Step 60 optionally record the request and the denial, which is either accessible or reported to the Accountability Partner Computer 24 then return back to Step 50 until the system is terminated. The system at Step 56 may at Step 62 optionally record the request and the access, which is either accessible or reported to the Accountability Partner Computer 24 then return back to Step 50 until the system is terminated.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. A system providing accountability and blocking of Internet use of a selected user, comprising:
a remote server;
a first computer having an accountability and blocking of internet use software program installed and communicatively linked to said remote server, wherein said program is configured to continuously block all Internet access unless Internet access is permitted by the remote server; and
a second accountability partner computer communicatively linked to said remote server, wherein a set of parameters for allowing remote server to unblock access to said first computer is established.

2. The system of claim 1, wherein said Internet access activity includes access selected from the group consisting of network news transfer protocols, file sharing programs, file transfer protocols, chat room access, peer to peer chats, http, https, cell phone, PDA, and electronic mail activity.

3. The system of claim 1, wherein the second computer notifies the remote server, by password-protected notification by non-internet electronic means such as through a website, that Internet access to the user of the first computer is permitted for a selected duration of time.

4. The system of claim 1, wherein the second computer notifies the remote server, by password-protected notification by non-internet electronic means, that Internet access to the user of the first computer is permitted for a predetermining time interval.

5. The system of claim 4, wherein said non-internet electronic means is by telephone.

6. The system of claim 1, further comprising a monitoring system, wherein said monitoring program is configured to monitor Internet access activity of the first computer's user and record said Internet access activity within said remote server, and wherein said remote server includes a processing program, said processing program configured to analyze said recorded Internet access activity and generate a report of said Internet access activity, wherein said report includes a list of said recorded Internet access activity and a score assigned to each said recorded Internet access activity and is accessible by said second computer.

7. The system of claim 6, wherein a score is assigned as a numeric indicator of the type of activity accessed, further characterized wherein an objectionable internet activity is accessed a high numeric score and a non-objectionable internet activity may be assigned a low numeric score, based on parameters such as key words and image content.

8. The system of claim 1, further including a first database located within said remote server, and wherein said monitored Internet access activity is stored on said first database.

9. The system of claim 1, further comprising a toolbar on said first computer to allow message to said second computer to prompt a request.

10. The system of claim 1, further comprising a comment section allowing the user to type in a comment after engaging in a particular internet access activity.

11. A method for providing accountability and blocking of Internet use of a selected user, comprising the steps in FIG. 2 of:
installing a remote server,
installing a program on a first computer, wherein said program which is configured to continuously blocked all Internet access unless Internet access is permitted by the remote server,
installing a second computer, at which an Accountability Partner communicates to the remote server that Internet access is permitted, unblocking access to the person using said first computer,
installing a monitoring system, wherein said monitoring program is configured to monitor Internet access activity of the computer user and record said Internet access activity within said remote server,
accessing internet activity selected from the group consisting of http, https, network news transfer protocols, file sharing programs, file transfer protocols, chat room access, peer to peer chats, and electronic mail activity, cell phones and PDAS and;
processing a recorded Internet access activity; and transferring said recorded Internet access activity to a second database.

12. The system of claim 11, wherein said report displays said list of said recorded Internet access activity sorted chronologically.

13. The method of claim 11, wherein providing said report includes electronically sending said report to said third party recipient at pre-selected time intervals.

14. The method of claim 11, wherein said report contains a list of recorded Internet access activity of one of said Internet protocols, and further includes a computer link to connect to a portion of said report.

15. The method of claim 11, wherein providing said report includes electronically sending said report to said third party recipient at pre-selected time intervals, comprising further, assigning a score to said Internet access activity based on predetermined scoring criteria, wherein said score is assigned as a numeric indicator of the type of activity accessed, further characterized wherein an objectionable internet activity is accessed a high numeric score and a non-objectionable internet activity may be assigned a low numeric score, based on parameters such as key words and image content.

16. The method of claim 11, wherein the Accountability Partner may permit access on a regular basis, optionally, every day at the same time.

17. The method of claim 11, wherein the Accountability Partner notifies the remote server, by password-protected notification such as through a website, by PDA, telephone, or by other electronic means, that Internet access to the user of the first computer is permitted.

18. A computer-readable medium comprising instructions and whose content cause a computer system to perform accountability and blocking of Internet use of a selected user, by performing the steps of:
installing a remote server,
installing a program on a first computer, wherein said program which is configured to continuously blocked all Internet access unless Internet access is permitted by the remote server,
installing a second computer, at which an Accountability Partner communicates to the remote server that Internet access is permitted, unblocking access to the person using said first computer,
installing a monitoring system, wherein said monitoring program is configured to monitor Internet access activity of the computer user and record said Internet access activity within said remote server, and
accessing internet activity selected from the group consisting of http, https, network news transfer protocols, file sharing programs; file transfer protocols, chat room access, peer to peer chats, cell phone, PDA and electronic mail activity.
